(19) United States
(12) Patent Application Publication
(10) Pub. No.: US 2025/0271362 A1
(43) Pub. Date: Aug. 28, 2025

(54) SELF WARMING SPECTROSCOPY INSTRUMENT AND METHOD

(71) Applicant: SciAps, Inc., Woburn, MA (US)

(72) Inventors: John Egan, Somerville, MA (US); Yen-Wei Lin, Wayland, MA (US); David Day, Boxford, MA (US)

(21) Appl. No.: 18/948,844

(22) Filed: Nov. 15, 2024

Related U.S. Application Data
(60) Provisional application No. 63/557,146, filed on Feb. 23, 2024.

(51) Int. Cl. G01N 21/71; G01N 1/44

(52) U.S. Cl. CPC G01N 21/718; G01N 1/44; G01N 2201/0221; G01N 2201/06113; G01N 2201/0693; G01N 2201/1212

(57) ABSTRACT

A spectroscopy instrument and method including a source of electromagnetic radiation, a controllable power source for energizing the source of electromagnetic radiation to direct the electromagnetic radiation to a sample for analysis by one or more spectrometers, and a temperature sensor. There is a controller, memory, and controller instrument warm-up instructions, stored in the memory. The instrument warm-up instructions are configured to read an output of the temperature sensor. If the temperature sensor output indicates an instrument temperature lower than a first setpoint, the power source is controlled to energize the source of electromagnetic radiation to heat the instrument. If the temperature sensor output indicates the instrument temperature is equal to or higher than a second setpoint, the power source is controlled to de-energize the source of electromagnetic radiation.

### RELATED APPLICATIONS

This application claims benefit of and priority to U.S. Provisional Application Ser. No. 63/557,146 filed Feb. 23, 2024, under 35 U.S.C. §§ 119, 120, 363, 365, and 37 C.F.R. § 1.55 and § 1.78, which is incorporated herein by this reference.

### FIELD OF THE INVENTION

This subject invention relates to spectroscopy instruments such as handheld, battery-operated laser induced breakdown spectroscopy (LIBS) instruments.

### BACKGROUND OF THE INVENTION

Various spectroscopic instruments are known. X-ray based instruments, for example, can be used to determine the elemental make up of a sample using x-ray florescence spectroscopy. X-rays, however, can pose a safety concern.

Laser induced breakdown spectroscopy (LIBS) devices are also known and used to detect the elemental concentration of lower atomic numbered elements with some accuracy. These devices typically include a high-powered laser source that sufficiently heats a portion of the sample to produce a plasma. As the plasma cools, eventually the electrons return to their ground states. In the process, photons are emitted at wavelengths unique to the specific elements comprising the sample. The photon detection and subsequent measurement of elemental concentrations are similar to spark optical emission spectroscopy (OES). An example of a LIBS device is described in US Pat. No. 9,719,853 incorporated herein by this reference.

When used in the field, cold environments can adversely affect the LIBS instrument. For example, the operation of the laser and/or spectrometer(s) can be adversely affected (e.g., laser power distribution at the laser focus on the sample and spectrometer intensity drifting), gain errors can increase in cold temperatures, and coefficient of thermal expansion effects of the instrument optics and the like can result in measurement errors.

Thus, in cold environments, the operator may warm up the instrument by repeatedly firing it for 5 to 30 minutes. The result is decreased productivity for the user and/or lower sample analysis quality if the instrument is not properly warmed up. Battery life can also be affected.

### SUMMARY OF THE INVENTION

Featured is the new spectroscopy instrument which is designed for cold environment operations.

Also featured is the new spectroscopy instrument which increases user productivity in cold environments.

Further featured is a new spectroscopy instrument exhibiting higher accuracy, better instrument stability, and better measurement quality in cold environment operations.

Battery life is also extended.

Realized, in embodiment, is a cold environment spectroscopy instrument which automatically and quickly warms itself up in a cold environment and keeps itself warm during use of the instrument. For a LIBS instrument, the instrument quickly warms itself up and keeps itself warm in cold environment by automatically energizing the laser at a current amplitude which causes the laser to produce heat, but which does not result in the laser firing. The native components of the LIBS instrument already in place are preferably used to warm the instrument. When measurements are being taken, the warm-up routine is disabled.

Featured is a spectroscopy instrument comprising a source of electromagnetic radiation, a controllable power source for energizing the source of electromagnetic radiation to direct the electromagnetic radiation to a sample for analysis by one or more spectrometers, and a temperature sensor. Controller instrument warm-up instructions are stored in a memory and configured to operate a controller to read an output of the temperature sensor. If the temperature sensor output indicates an instrument temperature lower than a first setpoint, the power source is controlled to energize the source of electromagnetic radiation to heat the instrument. If the temperature sensor output indicates the instrument temperature is equal to or higher than a second setpoint, the power source is controlled to de-energize the source of electromagnetic radiation.

The source of electromagnetic radiation is preferably a laser source having a threshold laser firing amperage and the controller instrument warm-up instructions are configured to control the power source to energize the laser source below its threshold laser firing amperage to heat the instrument in an instrument warm-up mode. In one example, the instrument is a portable, handheld, battery powered LIBS instrument.

The instrument may further include an actuator for firing the laser at or above the threshold laser firing amperage to analyze the sample and, during analysis, the controller instructions are configured to disable the instrument warm-up mode. The controller instrument warm up instructions are preferably automatically carried out whenever the instrument is powered on in cold weather conditions. The controller instrument warm-up instructions can be further configured to control the power supply to apply power to the laser source as a function of the difference between the instrument temperature and the first setpoint.

Also featured is a LIBS spectroscopy instrument comprising a laser source which fires a laser beam at or above a threshold laser source firing power, a controllable power source for supplying power to the laser source to direct a laser beam to a sample for analysis, one or more spectrometers for analyzing the resulting plasma proximate the sample, and a temperature sensor. There is a controller, memory, and controller instruction stored in the memory. Controller instrument warm-up instructions are configured to automatically control the power source to energize the laser source at a power level below the threshold laser source firing power to heat the instrument. Controller instrument analysis instructions are responsive to a trigger signal and configured to control the power source to energize the laser source at a level at or above the threshold laser source firing power to analyze the sample.

Also disclosed is a spectroscopy method comprising producing electromagnetic radiation from a source of electromagnetic radiation, controllably energizing the source of electromagnetic radiation to direct the electromagnetic radiation to a sample for analysis by one or more spectrometers, sensing an instrument temperature, and reading the instrument temperature. If the instrument temperature indicates an instrument temperature lower than a first setpoint, the source of electromagnetic radiation is energized to heat the instrument and if the temperature sensor output indicates the instrument temperature is equal to or higher than a second setpoint, the source of electromagnetic radiation is de-energized.

Preferably, the source of electromagnetic radiation is a laser source having a threshold laser firing amperage and heating the instrument includes energizing the laser source below its threshold laser firing amperage to heat the instrument in an instrument warm-up mode.

Also featured is a LIBS spectroscopy method comprising sensing the temperature of the instrument. Instrument warm-up instructions are configured to automatically energize the laser source at a power level below a threshold laser source firing power to heat the instrument when the instrument temperature is below a set point. Instrument analysis instructions, responsive to a trigger signal, are configured to energize the laser source at a level at or above the threshold laser source firing power to analyze the sample by directing the laser beam to a sample for analysis and analyzing the resulting plasma proximate the sample.

The subject invention, however, in other embodiments, need not achieve all these objectives and the claims hereof should not be limited to structures or methods capable of achieving these objectives.

### BRIEF DESCRIPTION OF THE DRAWINGS

Other objects, features and advantages will occur to those skilled in the art from the following description of a preferred embodiment and the accompanying drawings, in which:

FIG. 1 is a block diagram showing the primary components associated with an exemplary LIBS instrument;

FIG. 2 is a flow chart depicting the primary steps associated with the operation of the controller of FIG. 1;

FIG. 3 is a flow chart depicting another example of the programing of the controller of FIG. 1;

FIG. 4A is a graph of an example of current versus time in a full power warm-up mode;

FIG. 4B is a graph of an example of current versus time for a lower power warm-up mode; and

FIG. 5 is a block diagram showing the primary electronic components associated with an example of a LIBS instrument for implementing the warm-up mode.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

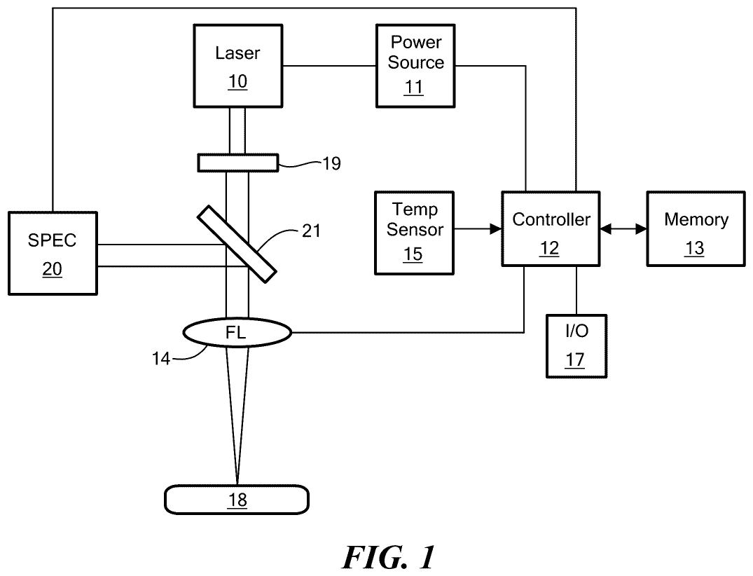

In the example of FIG. 1, a LIBS laser 10 directs its output, when energized by controller subsystem 12, to focusing lens 14 which produces a small spot (e.g., 100 μm) of laser energy on sample 18 creating a plasma.

The resulting photons of the plasma produced by the laser energy proceed along a detection path including focusing lens 14 to detector subsystem 20 (e.g., one or more spectrometers). The output signal of detector subsystem 20 may be processed by controller subsystem 12. Spectrometer 20 may include a CCD detector array. Other spectrometers include echelle (with a 2D CCD), Paschen-Runge, and the like.

Controller subsystem 12 may include one or more micro-processors, digital signal processors, analog and/or digital circuitry or similar components, and/or application specific integrated circuit devices and may be distributed (e.g., one micro-processor can be associated with the detector subsystem while a micro-controller can be associated with the device's electronic circuit board(s)). The same is true with respect to the logic, algorithms, software, firmware, and the like (controller instructions). Various electronic signal processing and/or conditioning and/or triggering circuitry and chip sets are not depicted in the figures. Additional optics including beam expansion, collimation, and/or adjustment optics are possible in some examples.

As noted prior, a cold environment can adversely affect the operation of such a spectroscopic instrument. In one example, the controller instructions for controller 12, FIG. 1 stored in memory 13 are configured (when executed) to automatically warm up the instrument in cold environment conditions as follows.

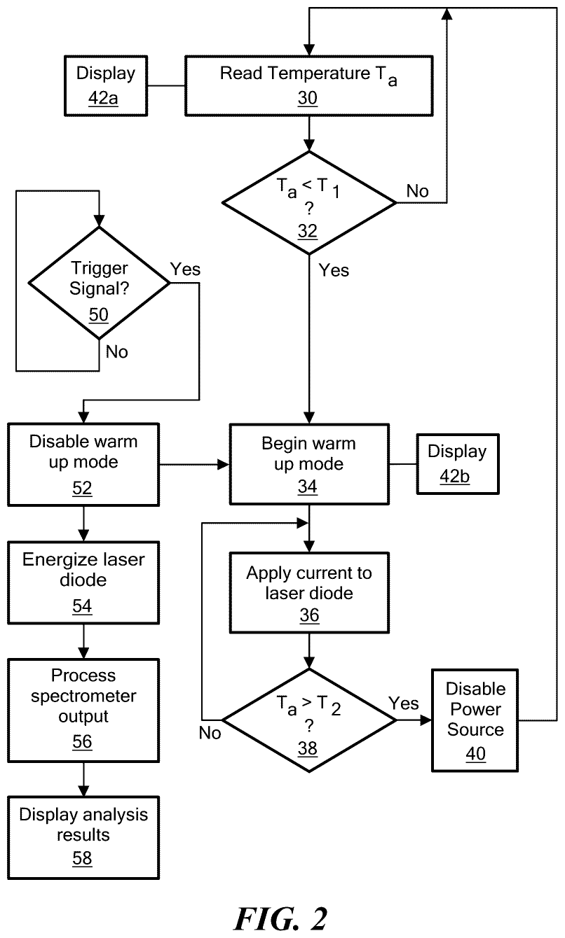

At step 30, FIG. 2, the controller instrument warm-up instructions periodically read the temperature sensor 15, FIG. 1 output to determine if the “ambient” temperature of the instrument Ta is below a first setpoint T₁ (e.g., 24 degrees C.), step 32. A temperature sensor is typically already included in a LIBS instrument to address and control thermal run-away conditions. If Tₐ is less than T₁, the warmup mode processing begins, step 34. The controller instructs the controllable power source to apply current to the laser (e.g., a diode laser) step 36, preferably at a current level less than the laser threshold firing amperage. In one example, the laser fires at 150 to 160 amps in pulsed signal trains and the warm-up mode current level is only 3 to 6 amps. Thus, the laser does not fire but it does produce heat. If the laser diode is in thermal contact with one or more instrument components, the instrument quickly warms up until its ambient temperature is above a second setpoint T₂, step 38, output by the temperature sensor and read by the controller at which point the controller instructions disable the power source, step 40 to end the warm-up mode. In some cases, T₁ and T₂ are the same value. In some examples, the warm-up mode continues until the temperature Tₐ reaches a higher value than T₁ (e.g. T₂=26 degrees C.). Proportional-integral-derivative (PID) type control techniques may be used.

At various times, the temperature of the instrument may be displayed, steps 42a, 42b. See input/output section 17, FIG. 1 including, for example, a touch screen.

In response to a trigger signal, step 50, FIG. 2, indicating the user is conducting a test, the controller instructions disable the warm-up mode, step 52 and energize the laser at its normal level, step 54, to fire the laser, produce plasma at or near the sample, and process the resulting spectrometer outputs, step 56 and display the analysis results, step 58 (e.g., a controller instrument analysis mode).

The warm-up mode can be carried out automatically anytime the instrument is turned (powered) on, when the user so instructs the device, and the like. The warm-up mode can also be disabled by the user, in some examples.

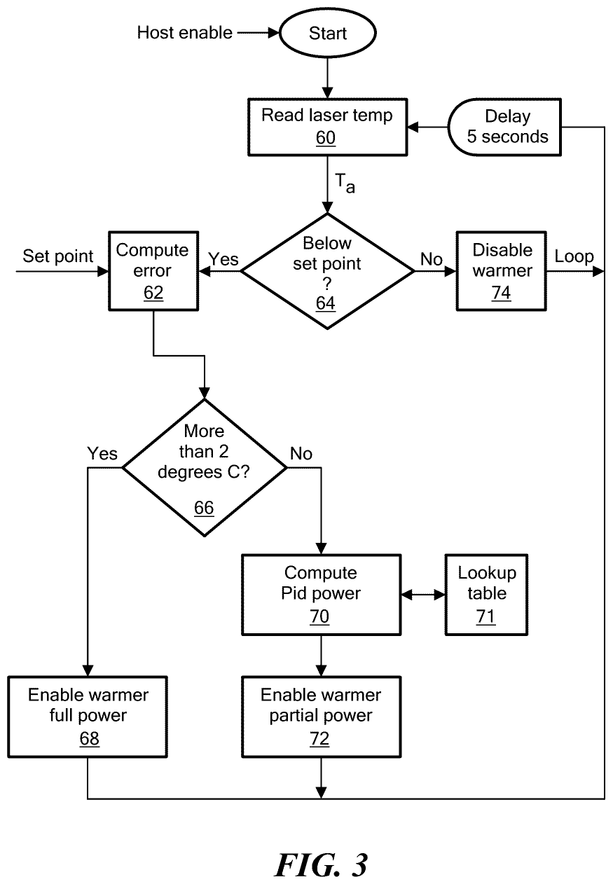

As shown in FIG. 3, in one example, the controller instrument warm-up instructions read the instrument temperature, step 60, compute the difference between the setpoint T₁ and the instrument temperature Tₐ, step 62. At step 64, if the instrument temperature is lower than the setpoint temperature and the computed difference at step 62 is more than a predetermined amount (e.g., 2 degrees C.), step 66, the full power warming mode may be enabled, step 68, If, at step 66, the instrument ambient temperature and the setpoint differ by less than the predetermined amount, a proportional power level is computed, step 70, (e.g., by referencing a look up table 71, for example) and is used to enable a partial power warming mode, step 72. Thus, as the instrument ambient temperature reaches a setpoint, the power applied is a function of how close the ambient temperature is to the setpoint. There is a delay (e.g., 5 seconds) and then the process begins again. When a setpoint in step 64 is reached, the instrument warming mode ends, step 74.

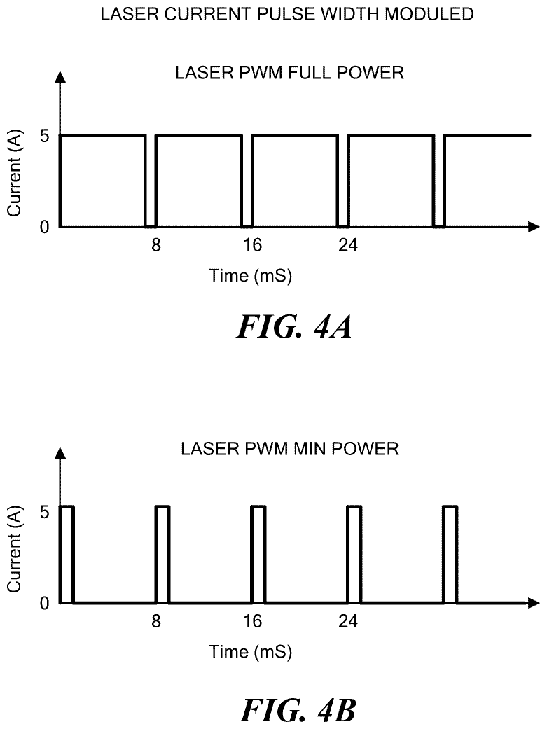

FIG. 4A shows an example of the full power instrument warming current pulse train (e.g., around 5 amps for 7 ms times spans between 1 to 2 ms off times) applied to the laser diode. FIG. 4B shows an example of partial power current pulse train (e.g., around 5 amps for 1-2 milliseconds times between 4-6 ms off times). In general, the pulses are shorter as the instrument approaches the target temperature. See steps 62 and 66, FIG. 3.

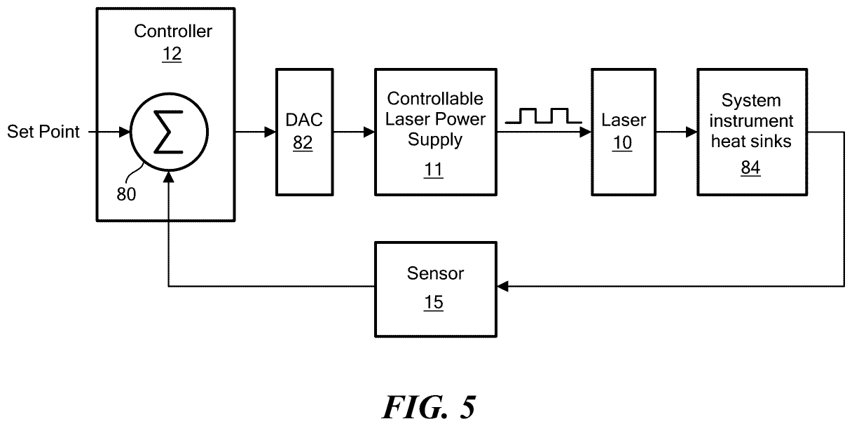

FIG. 5 shows temperature sensor 15, FIG. 1 applying a negative value to logic block 80 of controller 12 which also has a positive value setpoint input and the resulting difference is analyzed by controller 12 which, in turn, outputs a digital value of the current waveform (to be applied to the laser diode) to digital to analog converter 82 which, in turn, outputs an appropriate analog signal to laser power supply 11 which outputs the pulse train discussed above to laser 10, which although it does not fire, it produces the heat injected into the instrument including, in this example, heat sinks 84 in thermal contact with the laser diode.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant cannot be expected to describe certain insubstantial substitutes for any claim element amended.

What is claimed is:

1. A spectroscopy instrument comprising:
a source of electromagnetic radiation;
a controllable power source for energizing the source of electromagnetic radiation to direct the electromagnetic radiation to a sample for analysis by one or more spectrometers;
a temperature sensor; and
a controller, memory, and controller instrument warm-up instructions, stored in the memory, and configured to:
read an output of the temperature sensor,
if the temperature sensor output indicates an instrument temperature lower than a first setpoint, control the power source to energize the source of electromagnetic radiation to heat the instrument, and
if the temperature sensor output indicates the instrument temperature is equal to or higher than a second setpoint, control the power source to de-energize the source of electromagnetic radiation.

2. The instrument of claim 1 in which the source of electromagnetic radiation is a laser source having a threshold laser firing amperage and the controller instrument warm-up instructions are configured to control the power source to energize the laser source below its threshold laser firing amperage to heat the instrument in an instrument warm-up mode.

3. The instrument claim 2 in which the instrument is a portable, handheld, battery powered LIBS instrument.

4. The instrument of claim 2 further including an actuator for firing the laser at or above the threshold laser firing amperage to analyze the sample and, during analysis, the controller instructions are configured disable the instrument warm-up mode.

5. The instrument of claim 1 in which the controller instrument warm up instructions are automatically carried out whenever the instrument is powered on.

6. The instrument of claim 1 in which the controller instrument warm-up instructions are further configured to control the power supply to apply power to the laser source as a function of the difference between the instrument temperature and the first setpoint.

7. A LIBS spectroscopy instrument comprising:
a laser source which fires a laser beam at or above a threshold laser source firing power;
a controllable power source for supplying power to the laser source to direct a laser beam to a sample for analysis;
one or more spectrometers for analyzing the resulting plasma proximate the sample;
a temperature sensor; and
a controller, memory, and controller instruction stored in the memory and including:
controller instrument warm-up instructions configured to automatically control the power source to energize the laser source at a power level below the threshold laser source firing power to heat the instrument, and
controller instrument analysis instructions, responsive to a trigger signal, and configured to control the power source to energize the laser source at a level at or above the threshold laser source firing power to analyze the sample.

8. The instrument of claim 7 in which the instrument is a portable, handheld, battery-powered LIBS instrument.

9. The instrument of claim 7 in which the controller instrument analysis instructions are further to configured to disable the controller instrument warm-up instructions in response to the trigger signal.

10. The instrument of claim 7 in which the controller instrument warm-up instructions are configured to read an output of the temperature sensor and, if the temperature sensor output indicates a temperature lower than a first setpoint, control the power source to energize the laser source to heat the instrument.

11. The instrument of claim 7 in which the controller instrument warm-up instructions are automatically carried out whenever the instrument is powered on.

12. The instrument of claim 7 in which the controller instrument warm-up instructions are further configured to control the power supply to apply power to the laser source as a function of the difference between the instrument temperature and a setpoint.

13. A spectroscopy method comprising:
producing electromagnetic radiation from a source of electromagnetic radiation;
controllably energizing the source of electromagnetic radiation to direct the electromagnetic radiation to a sample for analysis by one or more spectrometers;
sensing an instrument temperature; and
reading the instrument temperature,
if the instrument temperature indicates an instrument temperature lower than a first setpoint, energizing the source of electromagnetic radiation to heat the instrument, and
if the temperature sensor output indicates the instrument temperature is equal to or higher than a second setpoint, control the power source to de-energize the source of electromagnetic radiation.

14. The method of claim 13 in which the source of electromagnetic radiation is a laser source having a threshold laser firing amperage and heating the instrument includes energizing the laser source below its threshold laser firing amperage to heat the instrument in an instrument warm-up mode.

15. The method of claim 14 in which the instrument is a portable, handheld, battery powered LIBS instrument.

16. The method of claim 14 further including, firing the laser at or above the threshold laser firing amperage to analyze the sample and, during analysis, disabling the instrument warm-up mode.

17. The method of claim 13 in which heating the instrument is carried out whenever the instrument is powered on.

18. The method of claim 13 in which heating the instrument includes applying power to the laser source as a function of the difference between the instrument temperature and the first setpoint.

19. A LIBS spectroscopy method comprising:
a laser source firing a laser beam at or above a threshold laser source firing power;
sensing an instrument temperature below a set point;
in response, executing instrument warm-up instructions configured to automatically energize the laser source at a power level below the threshold laser source firing power to heat the instrument; and
executing instrument analysis instructions, responsive to a trigger signal, to energize the laser source at a level at or above the threshold laser source firing power to analyze the sample by directing the resultant laser beam to a sample for analysis and analyzing the resulting plasma proximate the sample.

20. The method of claim 19 in which the instrument analysis instructions are disabled in response to the trigger signal.

21. The method of claim 19 in which the instrument warm-up instructions are automatically carried out whenever the instrument is powered on.

22. The method of claim 19 in which the instrument warm-up instructions are further configured to apply power to the laser source as a function of the difference between the instrument temperature and the setpoint.
